(19) United States
(12) Patent Application Publication
(10) Pub. No.: US 2020/0200882 A1
(43) Pub. Date: Jun. 25, 2020

(54) MULTICHANNEL ANALOG-DIGITAL CONVERTER DEVICE FOR AN OPTOELECTRONIC SENSOR, METHOD FOR SIGNAL MODULATION IN AN OPTOELECTRONIC SENSOR AND LASER-BASED DISTANCE AND/OR SPEED SENSOR

(71) Applicant: Robert Bosch GmbH, Stuttgart (DE)

(72) Inventors: Daniel Aquino Maier, Stuttgart (DE); Matthias Wichmann, Gaertringen (DE); Oliver Kern, Renningen (DE)

(21) Appl. No.: 16/709,032

(22) Filed: Dec. 10, 2019

(30) Foreign Application Priority Data
Dec. 20, 2018 (DE) 10 2018 222 415.3

(51) Int. Cl. G01S 7/4865; G01S 7/4861; G01S 17/89; G01S 17/34; G02F 7/00

(52) U.S. Cl. CPC G01S 7/4865; G01S 7/4861; G02F 7/00; G01S 17/34; G01S 17/89

(57) ABSTRACT

A multichannel analog-digital converter device for an optoelectronic sensor, including: an analog-digital converter unit; and a plurality of signal processing channels, the signal processing channels of the plurality of signal processing channels each having: a detection antenna to receive optical signals that are reflected by a pixel of an object, a combining unit to combine the detected optical signals with a modulated reference signal, a modulator to produce an individual signal coding, and a photodetector, signals having individual signal coding of the plurality of signal processing channels being capable of being transmitted together to the analog-digital converter unit.

### FIELD OF THE INVENTION

The present invention relates to a multichannel analog-digital converter device for an optoelectronic sensor, to a method for signal modulation in an optoelectronic sensor, and to a laser-based distance and/or speed sensor.

### BACKGROUND INFORMATION

There are various configurations for the analysis of the surrounding environment using lidar sensors (lidar: Light Detection and Ranging).

One used approach is the so-called macroscanner, in which a rotating macromirror, having a diameter in the centimeter range, deflects the beam over the field of view. The relatively large beam diameter has advantages with respect to maintaining eye safety, because the pupil diameter of 7 mm, assumed in norms (IEC 608125-1), can consequently receive only a fraction of the optical power contained in the beam. Moreover, a larger beam diameter is more robust against scattering influences such as rain or dust.

In another system configuration, microscanners are used. These are small mirrors having a diameter in the millimeter range (typically 1-3 mm), manufactured in MEMS technology and capable of pivoting in one or two axes in order to realize a beam deflection.

In addition, from the existing art lidar sensors are known that are realized with a barrel shape, a shoebox shape, or a can shape. In addition, currently solid-state lidar systems (SSL) are being developed that work without mechanical movement, i.e. without a movable mirror, for beam deflection. In addition to reduced costs, these systems also have advantages with respect to the influence of vibration, which play a role in, inter alia, the automotive field. An SSL-based approach is based on a beam deflection by so-called optical phased arrays (OPA). Here, the phase of individual antenna elements of an antenna array on a photonic chip is adapted such that the superposition of the parts of all antenna elements has an intensity maximum in the preferred direction. Significant challenges in this approach include, among others, the precise setting of the phase for each individual element as well as side lobes of the interference pattern radiated in other directions. In addition, a scanning system based on two gratings, not having a scanning element for two-dimensional beam deflection, is known from US 2017/0090031 A1.

Lidar systems measure the distance from an object using for example a direct runtime measurement (also called direct time-of-flight (DTOF)) of the radiated light pulse. A laser source sends out a light pulse that is deflected onto an object by a suitable unit. The object reflects the light pulse, and the reflected light pulse is measured by a detector and is evaluated. When runtime measurement is used, the system can ascertain the runtime on the basis of the times of the sent and received light pulse, and can ascertain the distance of the object from the transmitter/detector via the speed of light. Other methods are based on an indirect runtime measurement through modulation of the light intensity or of the light frequency itself. Here, an approach is the combination of frequency modulation and coherent detection (also called coherent frequency modulated continuous wave (FMCW)). WO 2018/067158 A1 is relevant existing art here.

### SUMMARY OF THE INVENTION

According to a first aspect, the present invention relates to a multichannel analog-digital converter device for an optoelectronic sensor. In the present context, a multichannel analog-digital converter device can be understood as an analog-digital converter to be situated inside an optoelectronic sensor, e.g. inside a lidar sensor, where a plurality of signal processing channels via which optical signals can be routed can be set up to guide optical signals to a single analog-digital converter. An optoelectronic sensor can be understood as, in particular, lidar-based and/or other laser-based sensors for scanning object areas. For example, according to the present invention optoelectronic sensors are lidar sensors that can be operated with a combination of frequency modulation and coherent detection (FMCW) and/or using a direct runtime measurement (DTOF). The multichannel analog-digital converter device according to the present invention includes an analog-digital converter unit that can be set up to sample electronic signals and convert them into digital signals, i.e. to digitize the electronic signals. A subsequent signal processor, e.g. a CPU, carries out signal processing steps, which can include the standard FMCW signal processing steps known from the existing art, unless an additional separation of the previously combined optical channels takes place. This can include for example a transformation method, such as a Fourier transformation method (e.g. a fast Fourier transformation method). The multichannel analog-digital converter device according to the present invention includes in particular a parallel plurality of signal processing channels, where each signal processing channel of the plurality of signal processing channels can include a detection antenna that is set up to receive optical signals that are assigned for example to a pixel of a sensor field of view. In particular, these signals are reflected into the pixel by a particular segment of an object. A detection antenna can have for example different spatial orientations, each spatial orientation in particular being assigned to a particular pixel. If, for example, a signal sent out by a transmission unit is reflected by a corresponding segment of an object, the detection antenna is set up to receive this reflected signal and to transmit it to the respective signal processing channel. In order to realize a detection antenna, for example a grating coupler in a chip and/or a collimator with a lens system can be used to couple in optical signals. In addition, each signal processing channel of the plurality of signal processing channels in particular includes a combining unit, e.g. an optical coupler, that is set up to combine the detected optical signals with a modulated reference signal. Here, for example within a method for operating an optoelectronic sensor such as the FMCW method for operating a lidar sensor, the modulated reference signal can be branched off from a modulated transmit signal. Each combining unit of each signal processing channel can be connected, via a reference channel, to the transmit channel of a transmit unit that sends out the modulated signal. In particular, the FMCW-specific modulation of the transmit unit is used for the determination of distance and speed. The modulators according to the present invention are used to distinguish pixels from one another. Within the combining unit, an interference between the transmitted and the received optical signal thus in particular takes place. This can be advantageous in order to assign the corresponding signals, which are assigned to pixels of a field of view, because for example an optical phase can also be modulated on a branched-off reference channel that goes into the combining unit, which is not possible in a DTOF measurement. In addition, each of the signal processing channels of the plurality of signal processing channels has a respective modulator that is set up to produce an individual signal coding within the signal processing channel. In particular, the individual signal codings that can be produced by the modulator within a signal processing channel are distinguishable from the modulated individual signal codings of other signal processing channels. In this way, different detection antennas can be spatially oriented to different pixels of the sensor field of view. Through the modulator, received signals of the for example differently spatially oriented antennas of the signal processing channels of the plurality of signal processing channels are, in other words, individualized. In addition, in particular each signal processing channel of the plurality of signal processing channels has a respective photodetector. The photodetector can in particular include a photodiode and/or a balanced detector. Through the balanced detector, in particular the signal resolution can be improved. At the same time, the direct portion of the superposed light can be suppressed. A balanced detector in addition permits a further possibility for situating the modulator, namely in one and/or both channels of the balanced detector. The photodetector is in particular set up to convert optical signals into electronic signals. Within the multichannel analog-digital converter device according to the present invention, the respective signals of the plurality of signal processing channels can be transmitted together, with individual signal coding, to the analog-digital converter unit. In other words, the signals, coded in an individualized manner, of the respective signal processing channels of the plurality of signal processing channels can be transmitted to an analog-digital converter unit so as to be distinguishable from one another. After digitization has taken place in the analog-digital converter unit, the digitized signal is supplied to a signal processor. Here, in particular via Fourier transformation or some other correlation method, such as cross-correlation with known codes, the corresponding signal can be assigned to a specific pixel on the basis of the initially individualized coding of the respective signals. In other words, after the digitization the signals can again be distinguished from one another and assigned to a specific pixel of the field of view. In this way, the number of required analog-digital converter units can be drastically reduced in comparison with the above-described systems from the existing art. According to the existing art, an evaluation of the signals reflected by the respective pixels of an object are digitized via single-channel analog-digital converters. However, this means that an individual analog-digital converter is required for each individual channel. In contrast, according to the present invention the number of analog-digital converters can be significantly reduced through the multichannel analog-digital converter device according to the present invention and the individual coding of the detected signals. In this way, in particular production costs can be saved. In addition, the measurement time per pixel can be increased through the parallelization of the signal processing channels, as well as individualized codings of the individual signals. In addition, the signal-to-noise ratio of the optoelectronic signal is improved by an increased measurement time per pixel. In addition, for a detection probability that remains the same (or a constant signal-to-noise ratio), the measurement time can be reduced, again saving costs.

The further descriptions and embodiments relate to further developments of the present invention.

According to an advantageous development of the multichannel analog-digital converter device according to the present invention, the signal processing channels, in particular all the signal processing channels, of the plurality of signal processing channels each have a photodetector and/or a combining unit, the combining unit being set up to combine the optical signals received by the detection antennas with a pre-modulated reference signal. For example, a transmit unit can be provided that is configured to produce a pre-modulated reference signal. The pre-modulated reference signal can be transmitted to the respective combining units via a reference channel. In this way, according to the present invention an FMCW method can be realized with the aid of the multichannel analog-digital converter device. Here, for example an optical beam splitter can be provided as combining unit, for example for a free beam configuration. In addition or alternatively, if the multichannel digital-analog converter device according to the present invention is situated in a lidar sensor configured as a fiber-based system, a fiber-based coupler may be used as combining unit. In addition or alternatively, the combining unit can include a photonic circuit. In a further advantageous embodiment, all optoelectronic functions (e.g. receiving, combining, modulating, merging, and/or an optoelectronic conversion) can take place on a PIC (photonic integrated circuit), and the signal processing can take place on an ASIC that is directly connected.

According to an advantageous development according to the present invention, the modulator can be situated in each case between the detection antenna and the combining unit and/or between the input of the reference channel at the combining unit and the combining unit and/or between the combining unit and the photodetector and/or between the photodetector and the analog-digital converter unit in a signal processing channel of the plurality of signal processing channels. This has the advantage in particular that the modulator can provide an individual coding both to the optical signal, i.e. between the detection antenna and the combining unit and/or between a combining unit and the branched-off reference channel going into the accommodation unit, and/or between a combining unit and the photodetector, and also the electronic material, or the electronic signals, i.e. between the photodetector and the analog-digital converter unit. As a result, the range of use of the modulator is variable. In this way, a variant-rich configuration of the modulator is possible. In addition, the modulator can also be situated at different positions in different channels. Here it is important only that the modulator produce coded signals in an individualized manner that can be different from the individual codings of other signals of other signal processing channels. For example, a modulator, depending on whether it is set up to modulate electronic signals or optical signals, can have an adjustable damping and/or amplification element and/or a thermal phase shifter and/or an electro-optical phase shifter.

According to a further advantageous embodiment of the multichannel analog-digital converter device according to the present invention, a plurality of detection antennas, in particular each detection antenna, of the plurality of signal processing channels can have a different spatial orientation. In other words, each detection antenna is directed to a different pixel of the field of view in relation to an object to be detected. In this way, an optoelectronic sensor can be realized in a compact and low-cost manner, because through the parallel evaluation of pixels large ranges (>100 m) and larger fields of view (>100°) and also large measurement rates (>1 megasample per second) can be achieved. For example, the plurality of signal processing channels can be 2 to 1000, which may be 4 to 100, in particular 4 to 16 signal processing channels. In this way, an optimal number of pixels can be addressed. In particular, a frequency-modulated transmit unit having a beam splitter can be present in the optoelectronic sensor that has the multichannel analog-digital converter device according to the present invention, the number of sent transmit signals matching the number of detection antennas. Due to the targeted beam guiding on the part of the transmit unit to different pixels, for example in the vertical direction, the detection antennas of the plurality of processing channels can receive the optical signals through corresponding orientations, directed to the respective segment of the object associated with the pixels in each case.

According to a further advantageous embodiment, the multichannel analog-digital converter device according to the present invention includes a signal superposition unit that is set up to superimpose the signals with individual coding before they are transmitted to the analog-digital converter unit. A summation unit may for example be used as signal superposition unit. In this way, the coded signals are transmitted together to the analog-digital converter unit. On the basis of this data packet, a complete transformation of the analog signals into digital signals can take place. In this way, the configuration of the multichannel analog-digital converter device according to the present invention can be simplified.

According to a further advantageous embodiment of the multichannel analog-digital converter device according to the present invention, the analog-digital converter unit is set up to digitize signals via a sampling method and a conversion. Using the downstream signal processor, spectra relating to the individual signal codings can be generated using a transformation method, which spectra correlate to the signals with individual signal coding produced by the modulator. In other words, the analog signals are provided with a coding by the modulator, and the coded signals are superimposed on one another and transmitted to the analog-digital converter unit. These signals are digitized in the analog-digital converter unit. Through the individual signal codings produced by the modulator, the signals can again be assigned to the originally detected signals, after a transformation by a signal processor connected downstream from the analog-digital converter. In other words, through the Fourier transformation it can be determined precisely which signals belong to the respective pixels. In this way, a multiplicity of signals having different codings can be digitized in parallel using only one analog-digital converter unit. In particular, the transformation method carried out by the signal processor includes a Fourier transformation method, in particular a fast Fourier transformation method. Here, a first Fourier transformation can be carried out, in which for example the maximum number of coded signals is produced. In a further Fourier transformation, through knowledge of the individual signal coding of the respective signals initially used in each case by the modulator, a filtering and/or a further Fourier transformation can be carried out with a reduced number of points. In this way, it can be unambiguously determined which spectra of the maximum number of spectra belong to which pixels. For better detection, in particular the spectra can be non-coherently integrated before the search for the maxima.

According to a further advantageous variant of the multichannel analog-digital converter device according to the present invention, the modulator is set up to code a respective received signal of a signal processing channel individually, i.e. in a distinguishable manner, relative to signals of other signal processing channels of the plurality of signal processing channels. Here, the number of measurements is in particular selected such that a subsequent separation of the coded signals is possible for the same pixel, because each of the measurements, in which all addressed pixels are regarded in parallel, is modulated with a different coding. However, if the number of measurements is sufficiently large (e.g. 10 measurements), then a significantly larger number of pixels can be processed within the same multichannel analog-digital converter device, because given 10 coding values, significantly more than 10 orthogonal codes can be produced. For example, the number of measurements can be from 2 to 10,000, in particular 3 to 100, in particular 2 to 18. In order to generate a distinguishable signal coding, in particular if for example 16 pixels are being addressed that are assigned to 16 signal processing channels, at least four measurements have to be carried out, if the pixels are modulated via binary values (e.g.: −1 and 1 and/or 0 and 1). In other words, all signal processing channels are measured in parallel four times and are subsequently processed in order to achieve the pixel assignment and to determine the distance and speed of the objects in a pixel. In the classical method, 16 measurements would be required in order to measure the 16 pixels/channels.

In this way, signals can be adequately individualized via signal codings. In this way, a high number of pixels can be addressed in parallel per analog-digital converter unit.

According to an advantageous embodiment of the multichannel analog-digital converter device according to the present invention, the modulator is in addition set up to modulate optical and/or electronic signals of the signal processing channels via an amplitude modulation and/or a phase modulation. For example, signals for an amplitude coding can be multiplied in a binary manner, i.e. by 0 or 1. In addition, the signals for an amplitude modulation can also be multiplied by −1 and 1. Here, given four parallel signal processing channels, four orthogonal codings are used. In addition, the phase modulation can take place via the multiplication of signals by a further signal, for example a sine wave having a very low frequency. Here, however, the frequency must be so low that over time a ramp of the value by which the signal is multiplied is constant. Through correlation, or Fourier analysis, with four points via the respectively associated peaks of the spectrum, the digitized signal can again be assigned to the originally modulated signal. In a phase modulation, the coding can in particular include a rotation of the signal by 0° or 180°. In particular, phase shifters can be used to modulate on a sine wave. Phase shifters in particular modulate a linear phase over a plurality of ramps, so that a four-point Fourier analysis has to be carried out over the detected peaks in the analog-digital converter unit in order to recognize which peak contains which frequency, in order in this way to determine to which pixel the frequency belongs.

Here, in particular the sent or received time signal of a single measurement of an FMCW method is referred to as a ramp. This is derived from the fact that the original transmit signal has e.g. a linearly increasing frequency, i.e. corresponds to a linear ramp in the time-frequency plane. As is known from the existing art, the distance and speed of an object can be determined via e.g. a rising and an additional falling ramp. For simplicity, in the present text a rising and a falling ramp are formally combined, and we speak only of one ramp, or measurement, for a distance and speed determination. If a plurality of measurements are carried out one after the other per pixel, in the present context we thus speak of a plurality of ramps.

In particular, amplitude and/or phase modulations are produced via the apparatus/device (arrangement) described above (for example via attenuating and/or amplifying elements, and/or thermal phase shifters and/or electro-optical phase shifters).

According to a further advantageous variant, the multichannel analog-digital converter device according to the present invention includes a transmit unit, the pre-modulated reference signal corresponding to a sent signal of the transmit unit. In particular, a reference channel can be provided that is set up to transmit a branched-off pre-modulated signal of the transmit unit to a respective combining unit of the signal processing channels. The device according to the present invention can carry out an FMCW method with a reduced number of required analog-digital converters and an increased measurement time per pixel, and therefore with a greater signal-to-noise ratio. In particular, a branching unit, for example an optical splitter, can be provided in order to transmit a pre-modulated optical reference signal to the reference channel.

The aspects of the present invention stated below include the technical features, the advantageous effects, and the variants according to the first aspect of the present invention. To avoid repetition, another embodiment is thus omitted.

According to a second aspect, the present invention relates to a method for signal modulation in an optoelectronic sensor. The method can be realized as an FMCW method and/or as a DTOF method. The method includes the step of a transmission of an optical signal, in particular a modulated one, to a plurality of pixels of a field of view. In a second step, the method includes a receiving of reflected optical signals relating to a plurality of pixels via a multichannel analog-digital converter device according to the first aspect of the present invention, via a respective signal processing channel of the plurality of signal processing channels. In a further step, in particular a pre-modulated reference signal of the sent modulated optical signal is combined with the received signal (in the case of an FMCW method). This can take place for example in the combining unit. In a further step, in particular the received signals are modulated in order to produce an individually coded analog signal. This can be done in particular using the measures described above. In a further step, the individually coded analog signals are superposed with one another. This can take place for example using a superposition unit. Subsequently, in particular the superposed and coded signals are transmitted together to an analog-digital converter unit, where they are digitized. The digitized signals are transformed by a signal processor using a transformation method, in particular multiple times, for example using a fast Fourier transformation method, so that the digital signals can be distinguished from one another. There subsequently follows an evaluation of the transformed superposed signals in order to assign them to the respective pixel. In this way, within this step known technical methods can be used to assign the distance or the speed of an object in each pixel. Here, the ascertaining of distance and speed can largely take place using methods known to those skilled in the art. In particular, a signal processor is used to ascertain a spectrum from the superposed digital signals, and the frequency maxima are sought. In the case of a parallelization of e.g. four signal processing channels, there are in particular four peaks in a spectrum. The frequency of the maxima of these peaks corresponds to a linear combination of a “range frequency” and a Doppler frequency. The allocation of the respective maxima to the signal processing channels subsequently takes place according to the present invention via the individual signal coding.

According to a third aspect, the present invention relates to a laser-based distance and/or speed sensor including an analog-digital converter device according to the first aspect of the present invention. In particular, the laser-based distance and/or speed sensor includes a lidar sensor operated in particular with an FMCW method. In particular, two multichannel analog-digital converter devices according to the present invention can be provided, each having 50 signal processing channels per lidar sensor. In addition, 10 multichannel analog-digital converter devices may also be used, each having 10 signal processing channels per lidar sensor. Moreover, four multichannel analog-digital converter devices are conceivable, each having 25 signal processing channels per lidar sensor. In addition, 10 multichannel analog-digital converter devices may be used, each having 16 signal processing channels per lidar sensor.

In the following, exemplary embodiments of the present invention are described in detail with reference to the accompanying drawings.

### BRIEF DESCRIPTION OF THE DRAWINGS

FIG. 1 shows a variant of the multichannel analog-digital converter device according to the present invention.

FIG. 2 shows a variant of a lidar sensor according to the present invention.

FIG. 3 shows a flow diagram of a variant of the method according to the present invention.

FIG. 4 shows an illustration of a signal assignment by a signal processor, according to the present invention.

### DETAILED DESCRIPTION

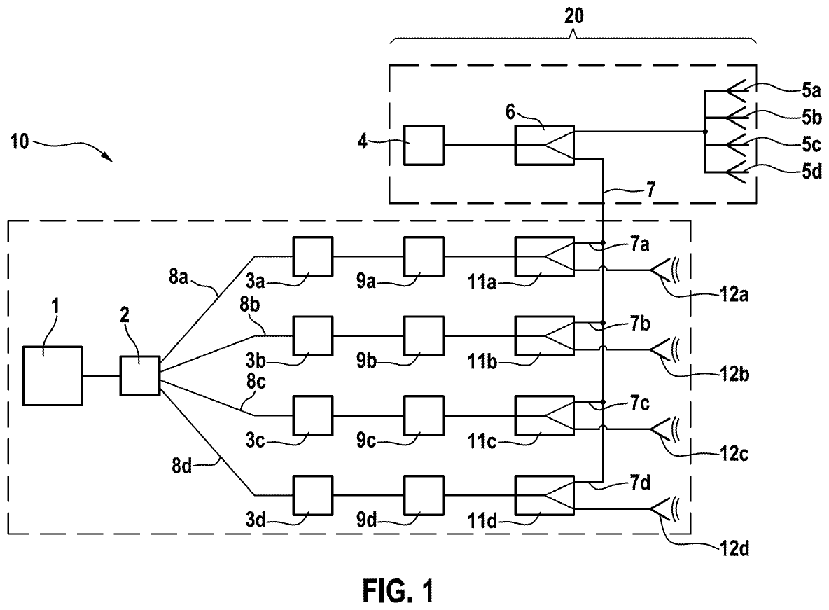

FIG. 1 shows an illustration of a variant of the multichannel analog-digital converter device 10 according to the present invention. Multichannel analog-digital converter device 10 according to the present invention has a transmit unit 20. Transmit unit 20 includes at least one laser source 4 and a branching unit 6, the latter being set up to transmit optical pre-modulated signals of laser source 4 to a first through fourth transmit antenna 5a through 5d, and to branch off a branched-off signal into reference channel 7. In particular, multichannel analog-digital converter device 10 according to the present invention is operated using an FMCW method. Laser source 4 produces a modulated optical signal that is sent, via one of first through fourth transmit antennas 5a through 5b, to a pixel of a field of view. For the assignment of the transmitted reference signal with respect to one of the reflected signals received via first through fourth detection antenna 12a through 12d, a pre-modulated reference signal is combined via reference channel 7, in one of first through fourth combining units 11a through 11d, with the reflected signals received via the first through fourth detection antennas, in order to assign the received signals to the transmitted signal. Here, in particular four branched-off reference channels 7a through 7d are present, in which a modulator 3a through 3d can also be situated. In particular, first through fourth transmit antennas 5a through 5d are assigned to different pixels. First through fourth detection antennas 12a through 12d receive the signals that are reflected by the respective segments of an object and that correspond to the respective transmit antenna 5a through 5d. For example, first detection antenna 12a receives the signal reflected by the object that was originally sent out by first transmit antenna 5a. In addition, second detection antenna 12b receives the signal originally sent by second transmit antenna 5b to a different segment of the object, etc. Each detected signal is sent to one of the first through fourth signal processing channels 8a through 8d, via detection antennas 12a through 12d. In first through fourth detectors 9a through 9d, in particular balanced detectors, the analog optical signals are converted into electronic signals. Through first through fourth modulators 3a through 3d, the signals routed via the respective first through fourth signal processing channels 8a through 8d are coded in an individualized manner, so that all signal codings are individually distinguishable from one another. If, in the present case, for example a binary coding is used by first through fourth modulators 3a through 3d, and the modulation is for example an amplitude modulation, then the amplitudes of the respective signals within the first through fourth modulators can for example be multiplied by −1 or 1 per measurement. Given four differently addressed pixels, per analog-digital converter unit 12 measurements are accordingly required per signal processing channel 8a through 8d in order to produce a distinguishable coding per signal. Here a signal is multiplied by one binary number per measurement. Given for signals received via first through fourth detection antennas 12a through 12d, in particular the first signal, received via first detection antenna 12a, is modulated with the binary sequence “−1, −1” inside first modulator 3a, the second signal, received via second receive antenna 12b, is modulated with the binary sequence “−1, 1” inside second modulator 3b, and the third signal, received via third detection antenna 12c, is modulated with the binary sequence “1, −1” inside third modulator 3c, and the fourth signal, received via detection antenna 12d, is modulated with the binary sequence “1, 1” inside fourth modulator 3d. In this way, all signals can be modulated with an individualized coding. In order to be able to distinguish from one another four different pixels that belong to first through fourth detection antennas 12a through 12d of first through fourth signal processing channels 8a through 8d, in other words, given a binary coding as described above, at least two measurements have to be carried out per pixel, or per antenna. All coded signals are then superposed with one another in a signal superposition unit 2. Subsequently, the signals are transmitted to analog-digital converter unit 1 in order to digitize these signals. In a downstream signal processor, these signals are subjected to a Fourier transformation, and can be distinguished from another after a Fourier transformation due to the initially individualized coding.

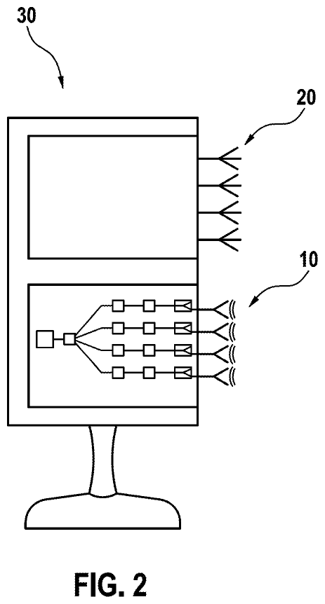

FIG. 2 shows a specific embodiment of a lidar sensor 30 according to the present invention. This lidar sensor 30 contains in particular multichannel analog-digital converter device 10 according to the present invention, as well as a transmit unit 20 as described above.

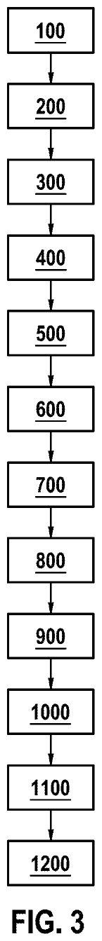

FIG. 3 shows a flow diagram of a specific embodiment of the method according to the present invention. In a first step 100, a modulated optical signal relating to a plurality of pixels of a field of view is sent out. In a second step 200, the reflected modulated optical signals, belonging to a plurality of pixels, are received via a multichannel digital-analog converter device 10 according to the first aspect of the present invention, via a plurality of signal processing channels 8a through 8d. In a third step 300, the branched-off modulated reference signals of the modulated sent signal are combined with the received reflected optical modulated signal. In a fourth step 400, the combined signals are modulated in order to produce an individually coded analog signal; in accordance with the above description, steps 300 and 400 can also be carried out in the reverse sequence. In a fifth step 500, the individually coded analog signals are superposed with one another, and in a sixth step 600 they are transmitted to an analog-digital converter unit 1 and digitized. In a seventh step 700, as described above, the measurements are repeated according to the number of pixels and the number of signal processing channels 8a through 8d. In an eighth step 800, a transformation, e.g. a fast Fourier transformation, of each measurement is carried out, resulting in M spectra (where M stands for the number of measurements) having up to N peaks (where the number of peaks stands for the number of pixels, under the assumption that not more than one target is to be detected per pixel). The transformation takes place in particular using a signal processor 13. In a ninth step 900, the spectra are averaged, and the positions of the N maxima are detected. In a tenth step 1000, the complex values of the N spectra at their positions are stored. This results in M×N values. In an eleventh step 1100, these M×N values are correlated with the original analog individual coding sequence. In a twelfth step 1200, the codings having the largest correlation are assigned to a respective peak. In this way, the pixel can be inferred through the greatest correlation with a peak.

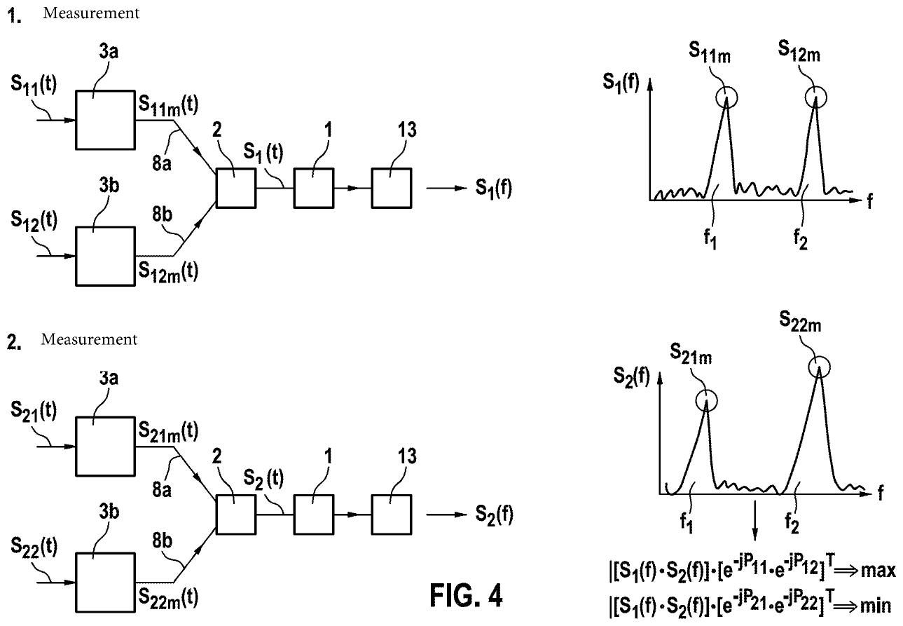

FIG. 4 illustrates a signal assignment according to the present invention using a signal processor 13. The signal assignment is shown for a simplified example of a multichannel analog-digital converter device 10 according to the present invention having two signal processing channels 8a, 8b, including two modulators 3a, 3b. A signal superposition unit 2, an analog-digital converter device 1, and a signal processor 13 are serially connected downstream from signal processing channels 8a, 8b. During a first measurement, one signal S₁₁(t) or S₁₂(t) is received per signal processing channel 8a, 8b. Through the respective modulators 3a, 3b, the signals S₁₁(t) and S₁₂(t) are correspondingly modulated with phase coding values P₁ₗ, P₁₂; the modulated signals S₁₁ₘ(t) and S₁₂ₘₜ) can be mathematically represented as follows:

S₁₁ₘ(t)=S₁₁(t)·e^{j·P11}

S₁₂ₘ(t)=S₁₂(t)·e^{j·P12}

Here, “j” is the imaginary part of the exponential function. From the modulated signals, a summed signal S₁(t)=S₁₁ₘ(t)+S₁₂ₘ(t) is produced using signal superposition unit 2. This summed signal S₁(t) is digitized by analog-digital converter unit 1, and is subsequently subjected to a fast Fourier transformation using signal processor 13, in order to obtain the spectrum S₁(f); this spectrum S₁(f), which results from the fast Fourier transformation, is shown as an example at the upper right side of FIG. 4. In the same way, a second measurement is carried out, the course of the second measurement being described by the equations

S₂₁ₘ(t)=S₁₁(t)·e^{j·P21}

S₂₂ₘ(t)=S₁₂(t)·e^{j·P22}

as well as S₂(t)=S₂₁ₘ(t)+S₂₂ₘₘ(t). The corresponding spectrum S₂(f), which results from the subsequent fast Fourier transformation, is shown at the right lower side of FIG. 4. Subsequently, the maxima are identified in the corresponding spectra S₁(f), S₂(f) resulting from the fast Fourier transformation. The number of maxima corresponds to the number of parallelized signal processing channels 8a, 8b; i.e. two in the present case. The complex amplitudes of these maxima contain the original phase codings, and can for example be identified via a vector multiplication and absolute value formation, as shown in FIG. 4 below the downward-pointing arrow. If the maxima contain noise, more than two measurements can be carried out. For example, it may happen that, for 16 signal processing channels, 10 successive measurements are carried out, whereby measurement time can, as before, be saved in comparison with 16 individual measurements without parallelization. If the phase values P increase linearly, each signal processing channel 8a, 8b having a different slope of these underlying straight lines, then the calculation can be replaced, as a simplification, by the fast Fourier transformation, because the above calculation mathematically results in a fast Fourier transformation for all signal processing channels and phase values.

1-11. (canceled)

12. A multichannel analog-digital converter device for an optoelectronic sensor, comprising:
an analog-digital converter unit; and
a plurality of signal processing channels;
wherein each of the signal processing channels of the plurality of signal processing channels include:
a detection antenna to receive optical signals; and
a modulator to provide an individual signal coding;
wherein signals having individual signal coding of the plurality of signal processing channels are transmittable together to the analog-digital converter unit.

13. The multichannel analog-digital converter device of claim 12, wherein the signal processing channels of the plurality of signal processing channels each having a photodetector and/or a combining unit, and wherein the combining unit is configured to combine the optical signals received by the detection antennas with a modulated reference signal that is receivable by a branched-off reference channel.

14. The multichannel analog-digital converter device of claim 13, wherein the modulator is situated respectively between the detection antenna and the combining unit and/or between the branched-off reference channel and the combining unit and/or between the combining unit and the photodetector and/or between the photodetector and the analog-digital converter unit, in, respectively, at least one signal processing channel of the plurality of signal processing channels.

15. The multichannel analog-digital converter device of claim 13, wherein at least one modulator of the plurality of signal processing channels is configured to modulate an amplitude and/or a phase of the received optical signal and/or of the signal combined in the combining unit and/or of the signal detected in the photodetector.

16. The multichannel analog-digital converter device of claim 12, wherein a plurality of detection antennas of the plurality of signal processing channels each have different spatial orientations.

17. The multichannel analog-digital converter device of claim 12, further comprising:
a signal superposition unit to superpose the signals having individual signal coding before their transmission to the analog-digital converter unit.

18. The multichannel analog-digital converter device of claim 12, wherein the analog-digital converter unit is configured to generate, via a digitization, digitized signals that correlate to the signals having individual coding that are providable by the modulator.

19. The multichannel analog-digital converter device of claim 18, further comprising:
a signal processor that is connected downstream from the analog-digital converter unit, wherein the signal processor is configured to transform the digitized signals to assign these to the signals, having individual coding, of the respective signal processing channels.

20. The multichannel analog-digital converter device of claim 13, further comprising:
a transmit unit, wherein the modulated reference signal corresponds to a sent signal of the transmit unit.

21. A method for signal modulation in an optoelectronic sensor, the method comprising:
sending an optical signal relating to a plurality of pixels of a field of view;
receiving reflected optical signals relating to a plurality of pixels of the field of view via a multichannel analog-digital converter device, via a respective signal processing channel of a plurality of signal processing channels, wherein the multichannel analog-digital converter device for an optoelectronic sensor includes:
an analog-digital converter unit; and
a plurality of signal processing channels;
wherein each of the signal processing channels of the plurality of signal processing channels include:
a detection antenna to receive the optical signals; and
a modulator to provide an individual signal coding;
wherein signals having individual signal coding of the plurality of signal processing channels are transmittable together to the analog-digital converter unit;
modulating the received optical signals to produce in each case an individually coded analog signal;
superposing a plurality of individually coded analog signals;
digitizing the superposed individually coded analog signals;
transforming the digitized signals; and
evaluating the transformed and digitized superposed signals to assign these to a respective pixel of the plurality of pixels.

22. A laser-based distance and/or speed sensor, comprising:
a multichannel analog-digital converter device for an optoelectronic sensor, including:
an analog-digital converter unit; and
a plurality of signal processing channels;
wherein each of the signal processing channels of the plurality of signal processing channels include:
a detection antenna to receive optical signals; and
a modulator to provide an individual signal coding;
wherein signals having individual signal coding of the plurality of signal processing channels are transmittable together to the analog-digital converter unit.
